(19) United States
(12) Patent Application Publication
(10) Pub. No.: US 2025/0230074 A1
(43) Pub. Date: Jul. 17, 2025

(54) CHEMICAL FREE EXTRACTION OF LITHIUM FROM BRINE

(71) Applicant: THE GEORGE WASHINGTON UNIVERSITY, Washington, DC (US)

(72) Inventors: Xitong LIU, Washington, DC (US); Lingchen KONG, Washington, DC (US)

(73) Assignee: THE GEORGE WASHINGTON UNIVERSITY, Washington, DC (US)

(21) Appl. No.: 19/074,681

(22) Filed: Mar. 10, 2025

Related U.S. Application Data
(63) Continuation of application No. PCT/US2023/074577, filed on Sep. 19, 2023.
(60) Provisional application No. 63/407,952, filed on Sep. 19, 2022.

(51) Int. Cl. C01D 15/02; B01D 61/44; C25B 1/14; C25B 9/17; C25B 11/043; C25B 11/047; C25B 15/08

(52) U.S. Cl. CPC C02F 1/4691; B01D 61/445; B01D 61/466; C01D 15/02; C02F 1/463; C25B 1/14; C25B 9/17; C25B 11/047; C25B 15/085; B01D 2311/2626; B01D 2311/2642; B01D 2311/2643; B01D 2311/2665; B01D 2311/2684; C01P 2006/80; C02F 2103/08

(57) ABSTRACT

The present invention relates to an integrated electrochemical lithium extraction process to directly produce lithium hydroxide from geothermal brine. The process integrates electrochemical silica removal, selective uptake and release of lithium using an intercalation material, and electro-driven generation of hydroxy (OH⁻) ions.

This application claims the benefit of U.S. Provisional Application No. 63/407,952, filed on Sep. 19, 2022, the entire contents of which are hereby incorporated by reference.

### FIELD OF THE INVENTION

The present invention relates to an integrated electrochemical lithium extraction process to directly produce lithium hydroxide from geothermal brine. The process integrates electrochemical silica removal, selective uptake and release of lithium using an intercalation material, and electro-driven generation of hydroxy (OH⁻) ions.

### BACKGROUND OF THE INVENTION

Current direct lithium extraction (DLE) technologies mainly include (i) solvent extraction, (ii) ion exchange/sorption, and (iii) nanofiltration. See, e.g., IEA (2021), The Role of Critical Minerals in Clean Energy Transitions, IEA, Paris, https://www.ica.org/reports/the-role-of-critical-minerals-in-clean-energy-transitions. While each of these technologies have various strengths and limitations, two significant barriers impede the practical application of them for lithium extraction from geothermal brine., e.g., The Geothermal Lithium Extraction Prize IAP Technical Panel, U.S. National Renewable Energy Laboratory, Apr. 27, 2021.The first barrier is the requirement of chemicals in the process, which may result in detrimental impacts of the chemicals to the process and to the environment. The second barrier is the complex composition of the brine, including high silica content and high total dissolved solids.

In solvent extraction, extractants that have a high affinity with lithium, such as chelating, acidic, and solvation extractants, are used to selectively extract lithium from brine. However, most of the reported extractants are non-commercial and expensive. See, e.g., Swain, J. Chem. Technol. Biot., 91, (10), 2549-2562, 2016. Furthermore, the use of acidic lithium stripping solutions can lead to equipment corrosion. See, e.g., Lithium Brine Extraction Technologies & Approaches, https://www.saltworkstech.com/articles/lithium-brine-extraction-technologies-and-approaches. In addition, due to the mixing at the solvent/brine interface, residue organic solvent ends up in the brine and cause two issues: (i) the solvent evaporates due to the high temperature of the brine, causing environmental damage, and (ii) costly post-treatment is required to remove the leached solvent before brine disposal, thereby increasing the cost for lithium extraction. See, e.g., The Geothermal Lithium Extraction Prize IAP Technical Panel, https://www.herox.com/GeothermalLithiumExtraction/update/3948.

In ion exchange/adsorption, a strong acid (e.g., HCl or H₂SO₄) is required for releasing the adsorbed lithium. Two issues arise with the use of acids: (i) the acid reacts with the ion exchanger/sorbent and causes material dissolution, and (ii) the regenerated lithium solution contains high concentration of corrosive acids. In addition, both ion exchange resins and inorganic adsorbents are prone to silica fouling, that is, the silica in the brine deposits in the pores of the resins and adsorbents, blocks the active sites, and makes the materials ineffective. Iron silicate, the most relevant scale formed from Salton Sea brine, fouls ion exchangers/sorbents and significantly undermines their performance and longevity. See, e.g., Gallup Geothermics, 18, (1-2), 97-103, 1989.

In nanofiltration, the membranes are vulnerable to fouling and scaling. Chemical anti-scalants are often added to the feedwater to suppress scale formation, and corrosive, costly cleaning agents are employed to clean the fouled membranes. See, e.g., Baker, Membrane Technology and Applications, Second Edition. John Wiley & Sons, 2004. A more important challenge faced by nanofiltration is the high salinity of Salton Sea brine. The total dissolved salts (TDS) of 296,000 mg/L corresponds to an osmotic pressure of greater than 300 bar, which is far above the maximum operating pressure for currently available membrane modules. See, e.g., Davenport, D. M., et al. Environmental Science & Technology Letters 2018, 5, (8), 467-475. This practically makes pressure-driven membrane systems infeasible for DLE from Salton Sea brine.

There is therefore a need for chemical free integrated electrochemical lithium extraction processes useful to extract lithium from geothermal brine and, for example, directly produce lithium hydroxide.

### SUMMARY OF THE INVENTION

The present inventors have developed a chemical-free electricity-driven direct lithium extraction technology to directly produce lithium hydroxide from geothermal brine. The process integrates electrochemically selective uptake and release of lithium using an intercalation material, and electro-driven generation of hydroxy (OH) ions to generate lithium hydroxide.

In one aspect, the present invention relates to a process for extracting (e.g., selectively extracting) lithium from brine to form, e.g., lithium hydroxide.

In one embodiment, the process comprises
(i) removing silica from the brine;
(ii) intercalating lithium ions onto a cathode;
(iii) storing chloride ions on an anode;
(iv) adding (e.g., rinsing with) water;
(v) releasing the lithium ions from the cathode and the chloride ions from the anode to form lithium chloride; and
(vi) converting the lithium chloride to lithium hydroxide

In another aspect, the present invention relates to a process for preparing lithium hydroxide from brine. In one embodiment, the process comprises
(i) removing silica from the brine;
(ii) intercalating lithium ions onto a cathode;
(iii) storing chloride ions on an anode;
(iv) adding (e.g., rinsing with) water;
(v) releasing the lithium ions from the cathode and the chloride ions from the anode to form lithium chloride; and
(vi) converting the lithium chloride to lithium hydroxide.

In one embodiment of any of the processes described herein, step (i) comprises aerating the brine to convert Fe²⁺ to Fe³⁺.

In one embodiment of any of the processes described herein, step (i) comprises precipitating the silica from the brine as iron (III) silicate.

In one embodiment of any of the processes described herein, step (i) further comprises electro-coagulation with an iron or aluminum electrode. In one embodiment of any of the processes described herein, step (i) further comprises electro-coagulation with an iron electrode. In one embodiment of any of the processes described herein, step (i) further comprises electro-coagulation with an aluminum electrode

In one embodiment of any of the processes described herein, the cathode comprises an intercalation material selective (e.g., greater than about 90% selective) to lithium ions (Li⁺).

In one embodiment of any of the processes described herein, the cathode comprises lithium iron phosphate (LiFePO₄), lithium manganese oxide (LiMn₂O₄), lithium cobalt oxide (LiCoO₂), lithium titanium oxide (Li₂TiO₃) or any combination thereof.

In one embodiment of any of the processes described herein, the cathode comprises lithium iron phosphate (LiFePO₄).

In one embodiment of any of the processes described herein, the anode comprises a carbonaceous material, e.g., a powdered activated carbon.

In one embodiment of any of the processes described herein, steps (ii) and (iii) are conducted at a voltage of between about 0.6 and about −0.2 V vs Ag/AgCl.

In one embodiment of any of the processes described herein, step (iv) removes desorbed lithium and/or chloride ions.

In one embodiment of any of the processes described herein, step (v) comprises reversing the voltage.

In one embodiment of any of the processes described herein, step (vi) comprises bipolar membrane electrodialysis (BMED).

In one embodiment of any of the processes described herein, the purity of the lithium hydroxide is greater than about 80%, such as greater than about 85%, greater than about 90%, greater than about 92.5%, greater than about 95%, greater than about 97.5%, greater than about 98%, or greater than about 99%.

In one embodiment of any of the processes described herein, the lithium hydroxide is lithium hydroxide monohydrate.

In one embodiment of any of the processes described herein, greater than about 80%, such as greater than about 85%, greater than about 90%, greater than about 92.5%, greater than about 95%, greater than about 97.5%, greater than about 98%, or greater than about 99% of the lithium in the brine is selectively extracted (e.g., converted to lithium hydroxide).

In one embodiment of any of the processes described herein, the brine is geothermal brine. In one embodiment of any of the processes described herein, the brine is Salton sea wellhead geothermal brine or Simbol feed brine.

### BRIEF DESCRIPTION OF THE DRAWINGS

FIG. 1 shows an exemplary flow chart for the processes described herein.

FIG. 2 shows an exemplary design for a lithium intercalation skid system.

FIG. 3 shows an exemplary lithium intercalation module.

FIG. 4 shows the crystal structure of FePO₄ for lithium intercalation (FIG. 4a), schematics showing the water stability window marked by H₂ and O₂ evolution reactions in geothermal brine (FIG. 4b); and CV tests for FePO₄ in 1 M lithium chloride aqueous solution at a 1 mV/s scan rate (FIG. 4c).

FIG. 5 shows a demonstration of IDI lithium extraction process from brines (FIG. 5a); a demonstration of IDI lithium chloride release process (FIG. 5b), and BMED for LiOH solution production (FIG. 5c).

FIG. 6 shows XRD patterns of as-fabricated LiFePO₄ and pre-delithiated FePO₄.

FIG. 7 shows specific capacity vs. Ewe curve by feeding DI water and 5 mM LiCl for Li release.

FIG. 8 shows the selectivity for lithium extraction from brines. Lithium and sodium concentration percentage at 1:1 (FIGS. 8a) and 1:77 (FIG. 8b) concentration ratio influent; and lithium selectivity over sodium with different influent concentration ratios (FIG. 8c). Lithium and other metal ion concentration percentage with Salton Sea geothermal brine as influent (Table1) (FIG. 8d), lithium selectivity over other metal ions with Salton Sea geothermal brine as influent (Table1) (FIG. 8e) Error bars indicate the standard deviation of duplicate measurements using different electrodes.

FIG. 9 shows metal element concentration percentage with complex Salton Sea geothermal brine influent.

FIG. 10 shows metal element concentration percentage in the purification process.

FIG. 11 shows lithium hydroxide production from BMED system. A, Li⁺, OH⁻, and Cl⁻ concentrations from the effluent in dilute-in channel (FIG. 11a); white solid LiOH·H₂O power after crystallization (FIG. 11b); and XRD patterns of produced LiOH.H₂O solid (FIG. 11c).

FIG. 12 shows the levelized cost of lithium (LCOL) as a function of electrode life (FIG. 12a) and extraction efficiency (FIG. 12b).

FIG. 13 shows an as-fabricated LiFePO₄ composite electrode.

FIG. 14 shows a specific capacity vs. Ewe curve in the pre-delithiation process.

FIG. 15 is a schematic diagram of an exemplary intercalative deionization cell for use in the processes described herein.

### DETAILED DESCRIPTION OF THE INVENTION

The present invention relates to an integrated electrochemical lithium extraction process to directly produce lithium hydroxide from geothermal brine.

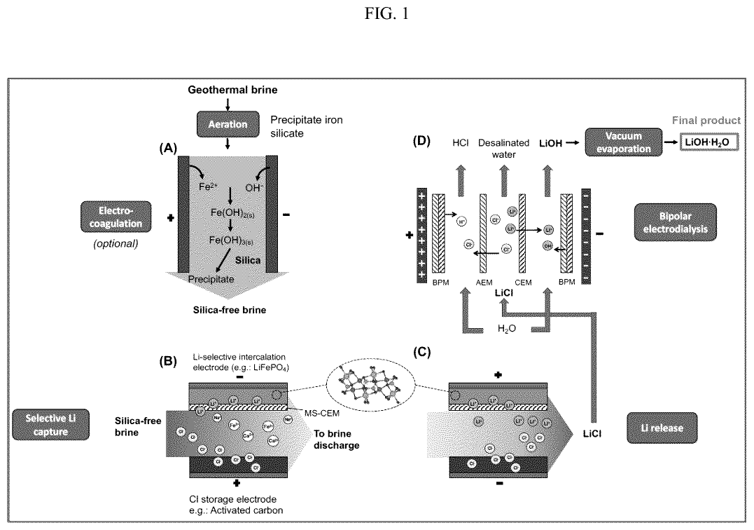

In one embodiment, the process integrates electrochemical silica removal, selective uptake and release of lithium using an intercalation material, and electro-driven generation of OH— ions. See FIG. 1.

In a first process step, silica is removed from the brine. In one embodiment, air is purged into the system to convert Fe²⁺ in the brine to Fe³⁺. The Fe³⁺ precipitates out with the silica as iron silicate. In a further optional embodiment, if the remaining silica concentration is still above oversaturation, electro-coagulation with an iron electrode may be used to further remove the dissolved silica. See FIG. 1A. Electro-coagulation has been tested in geothermal brine samples and achieved 90% removal of silica within 30 minutes using iron electrodes. Since geothermal brine contains a silica concentration of 460 mg/L and the solubility of silica is 350 mg/L at 100° C. and 165 mg/L at 50° C., removing 90% of the silica will ensure that silica will not precipitate out.

A second process step involves the selective separation of lithium from the brine using an intercalation electrolysis process. See FIG. 1B. In one embodiment, the cathode comprises one or more intercalation materials selective to Li⁺, resulting in storage of lithium in the sub-nanoscale channels of the intercalation electrode. For example, the intercalation material may comprise lithium iron phosphate (LFP, LiFePO₄), which offers high Li/Na selectivity and has high stability at low pH. This selectivity is based on thermodynamics of ion intercalation into a well-defined crystalline lattice. Other suitable intercalation materials which may be used in the present invention include, but are not limited to, lithium magnesium oxide and lithium cobalt oxide,

To prevent the adverse impacts of multivalent ions, such as Ca²⁺, Mg²⁺, and Fe²⁺, on the electrode longevity, a monovalent-selective cation exchange membrane (MS-CEM) may be used between the Li-electrode and the brine to reject multivalent ions

In one embodiment, the anode comprises a chloride-storage material, such as an activated carbon material. Additional anode materials may include, but are not limited, to bismuth oxychloride and silver.

In certain embodiment, the thickness of the electrode (cathode and/or anode) is between about 0.1 mm and about 0.5 mm, such as about 0.2 mm.

In certain embodiment, the density of the electrode (cathode and/or anode) is between about 0.2 g/cm³ and about 0.9 g/cm³.

In certain embodiment, the operating voltage is between about 0.6 V and about −0.2V vs. Ag/AgCl.

During the selective separation step, a voltage is applied while the brine flows between the two electrodes, and Li⁺ is selectively extracted to the cathode.

A third process step involves electrochemical removal of desorbed Li⁺ ions. In one embodiment, this third process step involves rinsing the system with water (e.g., distilled water) to remove the desorbed ions. The release of Li⁺ from the electrode is driven by electricity. See FIG. 1C. Upon reversal of the voltage, Li⁺ and Cl⁻ are released to the recovered solution. This step achieves electro-driven regeneration of both electrodes without the need to add corrosive acids.

In a fourth step, the process may further comprise an additional electrochemical process (following the selective lithium ion capture) to convert LiCl to LiOH, for example by bipolar membrane electrodialysis (BMED). This BMED process only requires electricity and pure water and produces LiOH and HCl. As shown in FIG. 1D, LiCl solution feeds from a middle channel and water feeds from two side channels. When a potential is applied, water undergoes splitting inside the side bipolar membranes and generates H⁺ at the positive electrode side and OH⁻ at the negative electrode side. Driven by the electric field, Cl⁻ ions pass an anion exchange membrane (AEM) to generate HCl. Li⁺ ions pass through the cation exchange membrane (CEM) to produce concentrated LiOH. The output from the middle channel is desalinated water for reuse. The product (LiOH·H₂O). with high purity may be obtained, for example, by vacuum evaporation (e.g., at 40° C.) using a rotavapor.

In one embodiment, the purity of the LiOH product (e.g., LiOH monohydrate) is greater than about 80%, such as greater than about 85%, greater than about 90%, greater than about 92.5%, greater than about 95%, greater than about 97.5%, greater than about 98%, or greater than about 99%.

Some advantages of the processes described herein include, for example:
(i) rapid lithium extraction. Electro-driven lithium extraction can produce the final product in a few hours.
(ii) high lithium extraction selectivity using a lithium-selective electrode and high extraction efficiency. The intercalation electrode has high selectivity between lithium and other ions. The geothermal brine in the Salton Sea contains 200 mg/L Li and 53,000 mg/L Na, corresponding to a Li/Na molar ratio of 0.0012. Based on the Nernst equation, the potential difference between Li and Na is

$${E}_{Li} - {E}_{Na} = {E}_{Li}^{0} - {E}_{Na}^{0} - 0.059 log \frac{[ {Na}^{+} ]}{[ {Li}^{+} ]}$$

E⁰_{Li}=0.36 V and E⁰_{Na}=0.19 V vs. standard hydrogen electrode, so E_{Li}-E_{Na} for Salton Sea brine is 0.058 V. This indicates that the extraction of Li from Na is thermodynamically favorable. By controlling the applied voltage such that Li is extracted but Na is not, the processes described herein are capable of extracting Li selectively.

(iii) Chemical input is minimized, with electricity as the sole input. Compared with solvent extraction, adsorption, and ion exchange, the processes described herein do not use toxic or corrosive chemical reagents, and are fully driven by electricity, thereby being more environmentally sustainable, and more compatible with a future driven by renewable energy.

(iv) Direct production of high purity LiOH as a product, with no further refining needed. The processes described herein include a bipolar electrodialysis system for generating LiOH from LiCl solution. High purity LiOH. H₂O may be generated as the end product.

(v) The processes described herein are compatible with the high complexity of the brine, especially the high silica content and high TDS. A pretreatment process to remove silica, including an aeration process to precipitate iron silicate, and an electrocoagulation process to further remove silica, if required, may be included. In addition, both the intercalation process and the bipolar electrodialysis can undergo periodic polarity reversal to clean off the precipitates that are deposited on the membranes or electrodes, thereby have high fouling tolerance. Unlike pressure-driven membrane technology, the process described herein does not require passing the high TDS brine through a membrane and thus requires only minimum energy for pumping the brine through the system.

(vi) A fully electrified process allows robust upscaling and integration with geothermal plants. Electrochemical systems are modular and thus highly scalable. The systems described herein can be scaled up by simply stacking the desired number of cells in series or in parallel. This technology can directly use the clean energy generated from geothermal plants.

### Reducing Environmental Impacts

The processes described herein will lower the environmental impacts of geothermal lithium extraction. 1) They avoid the risks and environmental damages associated with purchase, storage, and handling of harsh chemicals, such as organic solvents, strong acids, by relying on electricity as the sole input. 2) Current measures to control silica precipitation from geothermal brine rely on adding strong acids to the geothermal brine to kinetically suppress silica polymerization. This not only consumes large amounts of corrosive acids, but also raises environmental concerns when the brines are injected back to the reservoir. the environmentally friendly processes described herein to remove silica, including simple and electrocoagulation, improve the sustainability of the DLE process. 3) Compared with solar evaporation methods, this technology directly and selectively extracts lithium, while leaving the rest of constituents in the brine. As such, the chemistry of the brine is minimally impacted, so damage to the reservoir will be minimized.

### Silica Removal

An electrochemical process to firstly remove silica and some multivalent ions is described herein. The use of aeration to oxidize Fe²⁺ and to precipitate iron silicate, as a silica removal mechanism is included in the processes described herein.

### Brine Composition

The pH of the brine may be lowered by adding acid, to kinetically suppress silica polymerization. The processes described herein may be conducted at a pH of between about 5 and about 8, such as at a pH of about 5.2. At this pH, LFP electrode is stable.

### Desired DLE Technology Attributes

Several attributes of DLE that may be desirable from an application perspective include, for example, high extraction efficiency (extract as much Li as possible), high scalability (e.g., upscale to 1000 ton per hour capacity), and system robustness.

### Overall Design and Selection of Materials

LFP containing lithium intercalation sites may be used to store lithium from sodium with well-controlled voltage. LFP is stable at high temperature at 100° C.

The design of the process described herein is based on a zero chemical input principle. Various electrochemical processes were considered. Electrocoagulation is used to remove silica as pretreatment. Intercalation materials have been shown to exhibit high selectivity over sodium with controlled parameters. To generate LiOH, bipolar membrane electrodialysis may be used. Using conventional electrodialysis, lithium selectivity is difficult to achieve solely by relying on ion exchange membranes (IEM), and electrodialysis can only desalinate the brine but cannot produce LiOH.

Intercalation materials are able to achieve lithium selectivity over sodium but may suffer from electrode degradation caused by multivalent ions. The processes described herein firstly separate multi-valent ions by modified CEM and then extract Li by intercalation electrodes in the presence of Na.

### System and Module Design

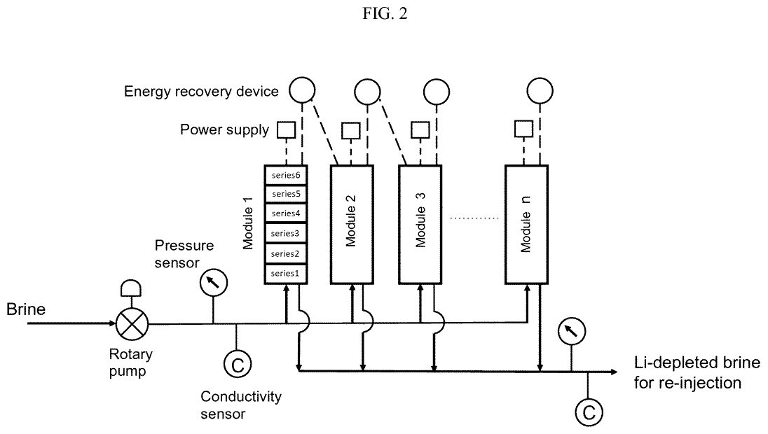

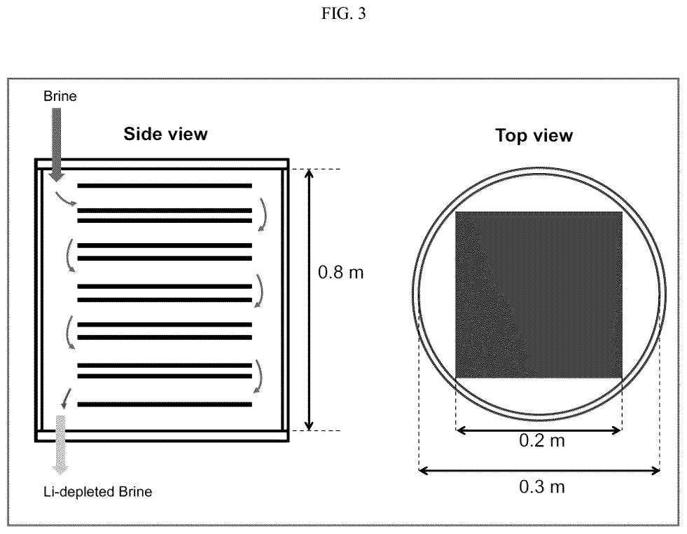

The systems and processes described herein are flow-by architectures in which brine flows between two opposing electrodes. In certain embodiments, a treatment train is comprised of one or multiple skids. In one exemplary embodiment, each skid contains 32 modules and balance-of-system components including a rotary pump, two pressure sensors, two conductivity sensors, 32 energy recovery devices, electronic controls, and valves and pipes. See FIG. 2. Each module may contain multiple square-shape electrode pairs housed in a cylinder enclosure See FIG. 3. In one embodiment, there are two configurations for the module: flow by, where the brine flows in parallel to electrodes, and flow through, where the brine flows through and perpendicular to the electrodes. Flow through configuration allows better mass transport efficiency due to the short diffusion path from solution to active sites. However, considering the complexity of the geothermal brine, flow through configuration is likely to suffer from electrode fouling and pore blocking issues. The processes described herein use flow by configuration (FIG. 3), which may have better long-term system level stability.

The Li adsorption capacity (LAC, mg/g) of the electrode (cathode) may be estimated from theoretical charge capacity of LFP:

$$LAC = \frac{1000 M {W}_{W\_Li} {C}_{cap}}{F}$$

where MW_{-Li} is the molecular weight of Li (6.94 g/mol); Ccap is the specific capacity of LFP [C/g]; and F is the Faraday constant [C/mol].

The mass-normalized average Li adsorption rate, ALARm [mg g⁻¹ min⁻¹], may be calculated from LAC and the duration of a charge-discharge cycle (τ, min). Based on a 1 C charging and discharging rate, τ=120 min.

$${ALAR}_{m} = \frac{LAC}{τ}$$

### Design of the Integrated Lithium Extraction and Refining System

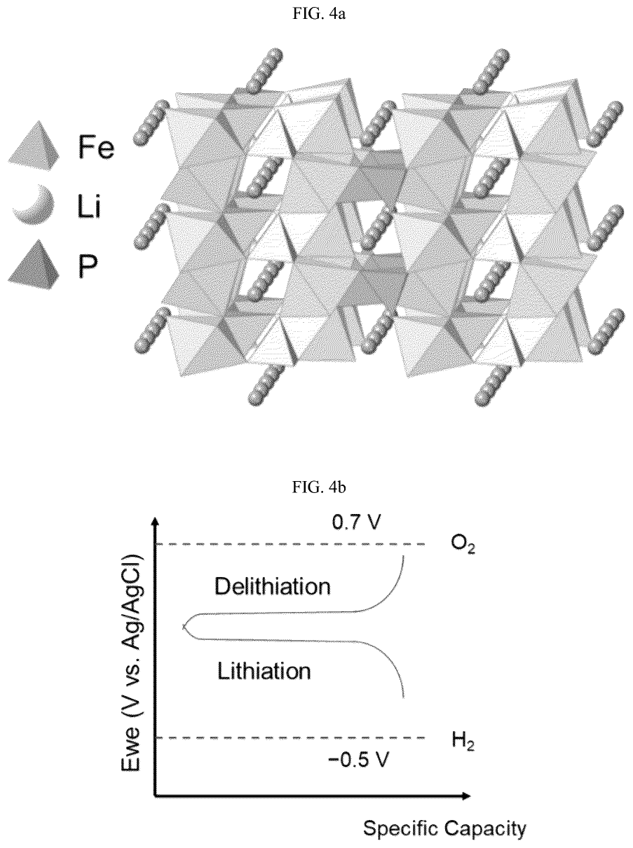

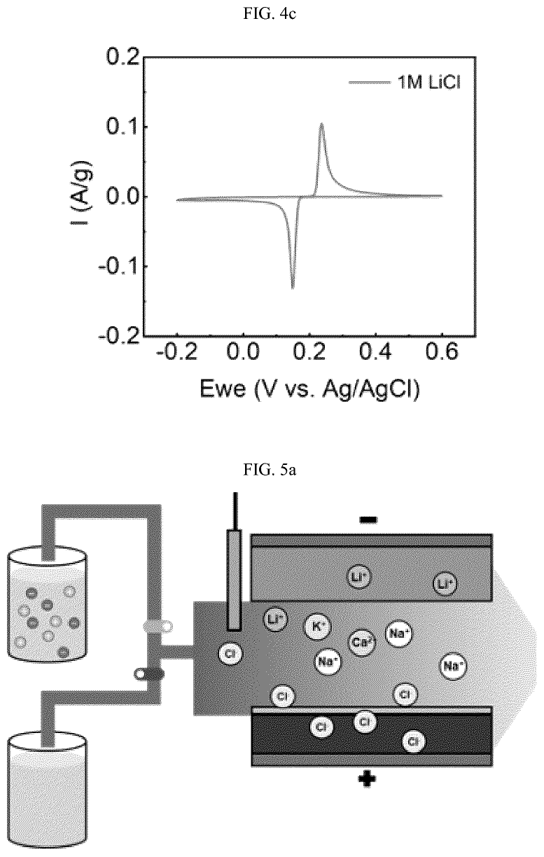

LiFePO₄ was is suitable as the working electrode because of its high Li selectivity, structural stability, and low Li intercalation energy barrier. The crystalline structure of LiFePO₄ is shown in FIG. 4a. Lithium ions can intercalate in the crystalline host materials and be stored in the lattice interstitial sites under electrical potential and released with reversed potential. Owing to the reversable intercalation and deintercalation, lithium intercalation materials can be used for lithium extraction in repeated cycles. During lithiation and delithiation, the electrode potential should be within the water stable window. Geothermal brine for lithium extraction has a pH of around 5.5, which sets the water stable window between about −0.25 V versus Ag/AgCl electrode to avoid H₂ evolution and 0.65 V versus Ag/AgCl to avoid O₂ evolution (as shown in FIG. 4b). FIG. 4c shows the cyclic voltammetry (CV) results for FePO₄ in 1 M LiCl solutions under 1 mV/s scan rate. The CV curve shows a pair of symmetric redox peaks indicating lithium capture and release. The theoretical potential plateau of lithiation and delithiation with 1 M Li salt solution for FePO₄ is about 3.4 V versus Li metal, which is 0.21 V versus Ag/AgCl. The half-wave potential (E_{1/2}=0.20 V vs. Ag/AgCl) is close to the theoretical thermodynamic value.

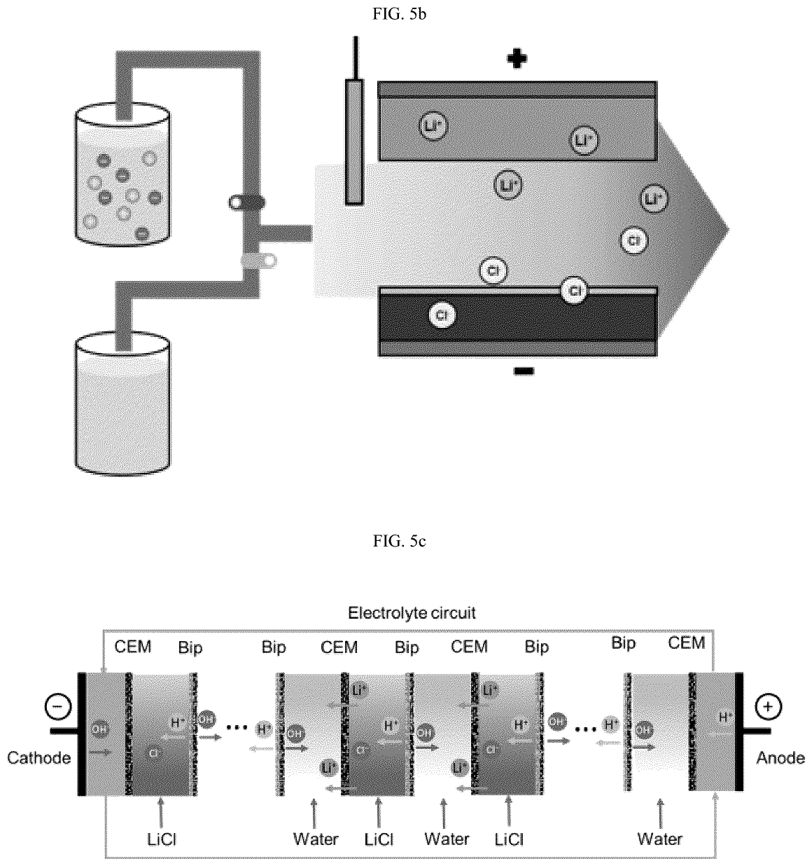

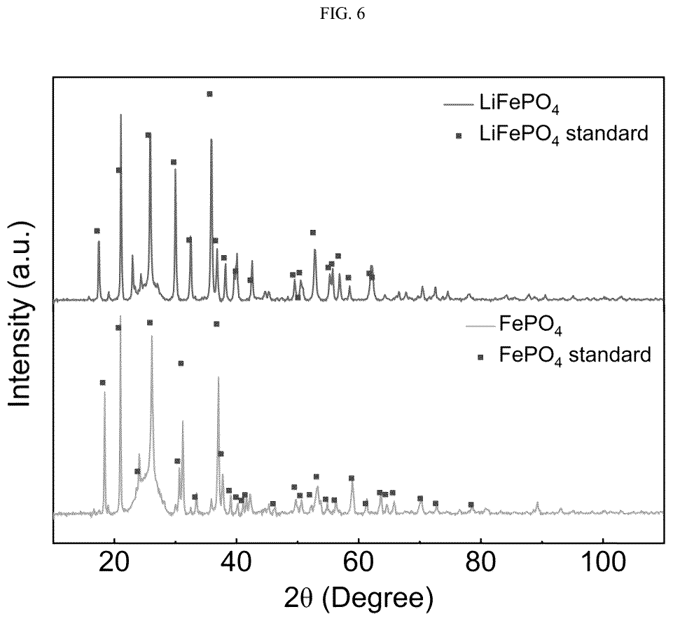

An exemplary working principle of extracting Li from geothermal brine using an integrated electrochemical process is illustrated in FIG. 5. FIGS. 5a and 5b show the lithium chloride production by combining intercalative and capacitive electrodes. As-fabricated LiFePO₄ was first pre-delithiated to FePO₄ confirmed by XRD patterns (see FIG. 6) and assembled in the cell together with activated carbon (AC) as the counter electrode. During the extraction stage, brine flows into the cell to allow lithium to be selectively intercalated in the FePO₄ electrode and chloride capacitively stored on the AC electrode; in the release stage, by switching the feed source and reversing the potential, lithium ions are deintercalated and chloride ions are desorbed to obtain concentrated lithium chloride as effluent. Lithium hydroxide production process is schematically shown in FIG. 5c. With the potential bias applied, protons and hydroxide ions are generated from each side of the bipolar membranes. Lithium ions transport through the cation exchange membranes and form lithium hydroxide in the concentrate channel.

### High Selectivity of Li Extraction from Simulated Geothermal Brines

Geothermal brines contain complex compositions with tens of species detected. An example of Salton Sea geothermal brine component concentrations was applied in these experiments. Table 1 shows the molar concentrations of major components for wellhead Salton Sea geothermal brine. The molar concentration ratios of Li/Na, Li/Ca, Li/K are about 1:77, 1:23, and 1:14. Because Li and Na have a very similar chemistry and sodium is the main component and a competitor for lithium intercalation during extraction, Li and Na binary solutions and two synthetic geothermal brines were selected for study. Four solutions were tested: 30 mM Li⁺ and 30 mM Na⁺ (Li/Na=1:1); 30 mM Li⁺ and 2.3 M Na⁺ (Li/Na=1:77); 30 mM Li⁺, 2.3 M Na⁺, 690 mM Ca²⁺, 430 mM K⁺ and 1.5 mM Mg²⁺ to simulate the main ion components of wellhead Salton Sea brine (synthetic geothermal brine A), and 42 mM Li⁺, 3.1 M Na⁺, 1070 mM Ca²⁺, 540 mM K⁺, 36 mM Fe²⁺, and 47 mM Mn²⁺ to simulate the Simbol feed Salton Sea brine after power generation and silica removal (see Table 2).

TABLE 1
Major Components in Salton Sea Wellhead Geothermal Brine

| Analyte | Concentration (mM) |
|---|---|
| Lithium | 30 |
| Sodium | 2300 |
| Calcium | 690 |
| Potassium | 430 |
| Magnesium | 1.5 |

TABLE 2
Composition of the Simbol Feed Brine (SFB)

| Analyte | Concentration (mM) |
|---|---|
| Lithium | 42 |
| Sodium | 3100 |
| Potassium | 540 |
| Calcium | 1070 |
| Iron | 36 |
| Manganese | 47 |

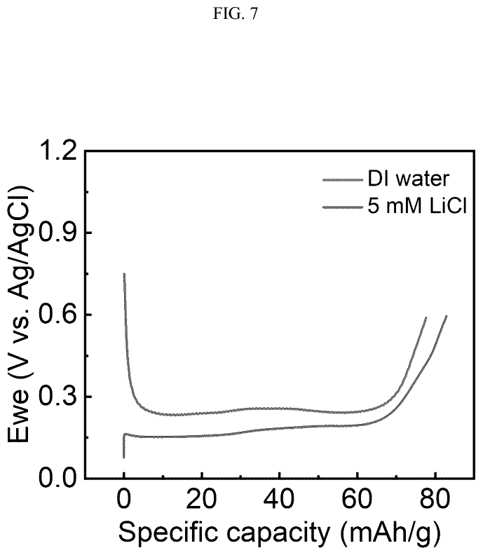

Initially, a 1:1 Li-Na binary solution was investigated for lithium extraction, using DI water for lithium release to obtain LiCl. From specific capacity vs. Ewe curve (see FIG. 7), the electrode potential increased to over 0.75 V vs. Ag/AgCl at the beginning of the release process, which is attributed to the high electrical resistance of DI water. Voltage beyond water stability window will induce O₂ evolution reaction and cause the electrode to undergo structural degradation. Previous work used indifferent electrolytes like magnesium chloride or ammonium chloride for lithium release to maintain a high electrical conductivity. However, this approach requires further purification of LiCl from the mixed electrolyte and is undesirable in practice. Here, we replaced DI water with 5 mM LiCl, which maintains the electrical conductivity and doesn't introduce any impurities to the effluent. Using 5 mM LiCl as the release solution, the initial electrode potential increases gradually (see FIG. 7) and is thus more favorable for the electrode structural stability. The concentration percentage in the released solution Li_{released}⁺ % may be calculated as followed:

$${Li}_{released}^{+} \% = \frac{\text{?}}{\text{?}} \times 100 \% \qquad ( 1 )$$

$$\text{?} \text{indicates text missing or illegible when filed}$$

The lithium extraction selectivity over sodium P_{Na}_{⁺}^{Li}^{⁺} may be calculated as followed:

$${P}_{{Na}^{+}}^{{Li}^{+}} = ( \frac{\text{?}}{\text{?}} ) / ( \frac{\text{?}}{\text{?}} ) \qquad ( 2 )$$

$$\text{?} \text{indicates text missing or illegible when filed}$$

c_{inf,Li}_{⁺} and c_{inf,Na}_{⁺} are the lithium and sodium concentrations in the influent, respectively; c_{eff,Na}_{⁺} is the sodium concentration detected in the effluent release solution; c_{released,Li}_{⁺} is the lithium concentration change in release solution.

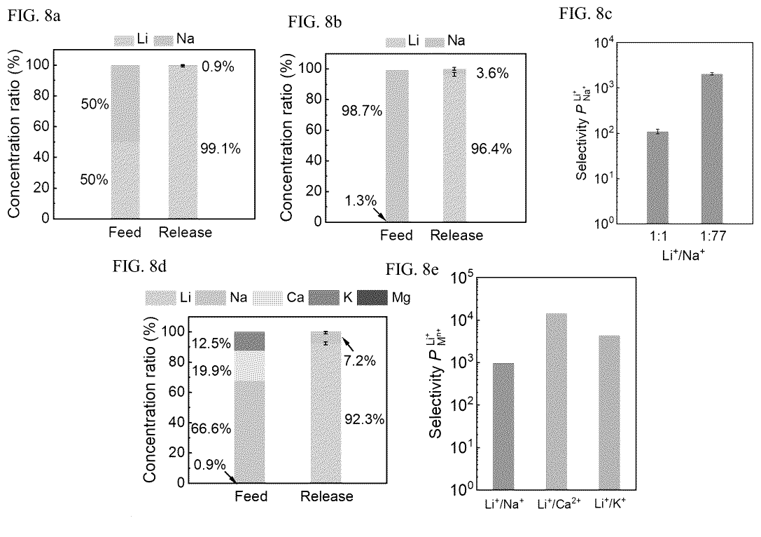

With Li/Na=1:1 influent, the molar fraction of Li reached 99.1%±0.5% in the effluent (see FIG. 8a). The Li selectivity over sodium P_{Na}_{⁺}^{Li}^{⁺} is calculated as 1.10×10² (see FIG. 8c). This experiment confirmed that the hybrid intercalation deionization process can achieve highly selective lithium extraction similar to beaker system reported previously.

Next, the Li extraction performance in 1:77 Li—Na binary system was investigated. This molar ratio is the same as that in the Salton Sea wellhead geothermal brine. Li purity is 96.4%±1.2% in the effluent (see FIG. 8b). The Li selectivity over sodium P_{Na}_{⁺}^{Li}^{⁺} is calculated as 2.05×10³ (see FIG. 8c). From the comparison of P_{Na}_{⁺}^{Li}^{⁺} with different influent concentration ratio, selectivity dramatically increased because the initial Li concentration percentage decreased significantly.

Following successfully extracting lithium chloride from high sodium concentration brine in a flow cell, lithium selectivity test was conducted with synthetic geothermal brine A which contains sodium, calcium, potassium, and magnesium. Lithium molar fraction in the released solution Li_{released}⁺ % can be calculated as followed:

$${Li}_{released}^{+} \% = \frac{\text{?}}{\text{?}} \times 100 \% \qquad ( 3 )$$

$$\text{?} \text{indicates text missing or illegible when filed}$$

The other individual metal concentration percentage in the released solution M_{released}ⁿ⁺ % can be calculated as followed:

$${M}_{released}^{{n}^{+}} \% = \frac{\text{?}}{\text{?}} \times 100 \% \qquad ( 4 )$$

$$\text{?} \text{indicates text missing or illegible when filed}$$

The lithium extraction selectivity over another metal ion P_{M}_{ⁿ⁺}^{Li}^{⁺} L Mn+can be calculated as followed:

$${P}_{{M}^{{n}^{+}}}^{{Li}^{+}} = ( \frac{\text{?}}{\text{?}} ) / ( \frac{\text{?}}{\text{?}} ) \qquad ( 5 )$$

$$\text{?} \text{indicates text missing or illegible when filed}$$

c_{inf,M}_{ⁿ⁺} and c_{eff,M}_{ⁿ⁺} are concentrations of a metal ion in the influent feed and in the effluent released solution, respectively.

Lithium molar fraction is around 0.8% in the influent and becomes about 92.3%±1.0% in the effluent according to equation (3). Concentrations of the other four ions significantly decreased in the effluent. The concentrations of the other four ions significantly decreased in the released solution. Sodium decreases from 66.6% in the feed to 7.2% in the release, calcium decreased from 19.9% to 0.2%, potassium decreased from 12.5% to 0.3%, and magnesium is undetectable in the released solution (see FIG. 8d). According to the selectivity calculation equation (5), lithium selectivity over sodium P_{Na}_{⁺}^{Li}^{⁺} is 9.83×10², lithium selectivity over calcium P_{Ca}_{²⁺}^{Li}^{⁺} is 1.48×10⁴, and lithium selectivity over potassium P_{K}_{⁺}^{Li}^{⁺} is 4.41×10³ (see FIG. 8d), all are remarkably high and consistent with our theoretical predictions.

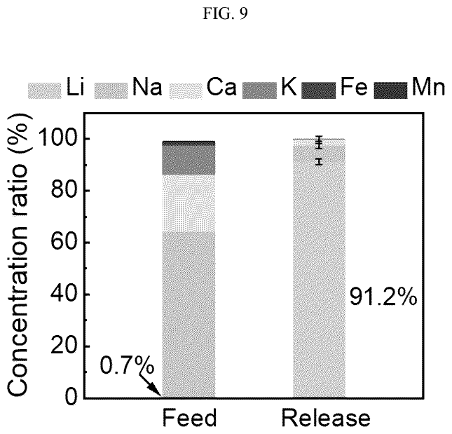

To further evaluate the reliability of the lithium extraction system with more realistic brine sample, we tested synthetic geothermal brine B with more complex composition based on the Simbol Feed Brine (Table 2). The brine contains iron, manganese, boron, strontium and ammonia besides lithium, sodium, calcium, and potassium tested earlier. By conducting the same extraction and release IDI experiments, lithium molar fraction is only around 0.7% in the influent and increases to about 91.2%±1.1% in the effluent according to Equation (3) (see FIG. 9). In the presence of oxygen, oxidation of ferrous ions (Fe^{II}) to ferric ions (Fe^{II}) results in the precipitation of hydrous iron oxides. Since the whole system is partially exposed to air, the oxidation of some ferrous irons is expected to occur. Although the brine contains colloidal particles that are likely to cause scaling issues, lithium purity still remains over 90% in the effluent release solution, demonstrating the robustness of the technology.

### Generation of Battery-Grade Lithium Hydroxide

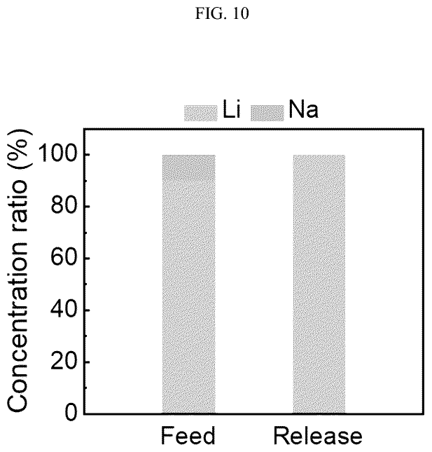

For battery-grade LiOH production, pure LiCl solution is desired to feed into the BMED system. Therefore, a one-step purification was conducted with the same IDI system. While feeding in 90% Li and 10% Na solution, 100% Li was obtained in the effluent and Na was not detected (see FIG. 10). When pure LiCl and DI water flow into the BMED system with a potential applied, electrolysis occurs on the bipolar membranes, H⁺ releases from the anion exchange side and OH⁻ releases from the cation exchange side. Li⁺ migrates through the cation exchange membrane and forms LiOH with generated OH⁻. FIG. 1la shows the concentration of ions in the dilute-in channel as a function of time. LiOH was gradually generated in the channel, and Cl-concentration is always negligible. The Purity_{LiOH} was calculated as followed:

$${Purity}_{LiOH} \% = \frac{\text{?}}{\text{?}} \times 100 \% \qquad ( 6 )$$

$$\text{?} \text{indicates text missing or illegible when filed}$$

c_{Cl}_{^{−}} and c_{OH}_{^{−}} are the concentrations of Cl⁻ and OH⁻. T

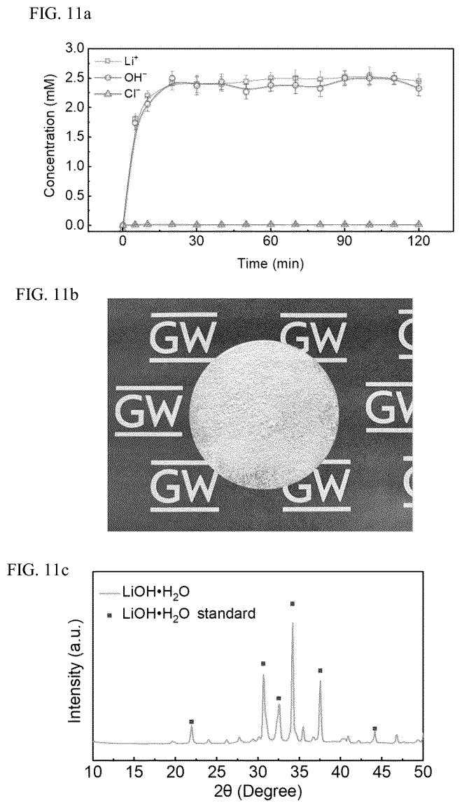

The average purity of LiOH produced is 99.6%±0.2% which reaches battery manufacturing grade. The collected LiOH solution was subjected to rotary evaporation, which facilitates the crystallization process to form LiOH·H₂O white power solid (see FIG. 11b). The LiOH·H₂O crystal structure was confirmed by XRD patterns (see FIG. 11c).

### Techno-Economic Assessment of the Intercalative Lithium Extraction Process

Techno-economic assessments (TEA) were also conducted for the lithium extraction processes using intercalation material. The details for the TEA are presented below. The contribution of both capital and operating costs to levelized cost of lithium (LCOL, $/kg LiOH·H₂O extracted) were considered.

Capital costs (Capex) include the costs of electrodes, IEMs, auxiliary module components (spacer, current collector, and housing), the balance of system components (sensors, pumps, valves and piping, electrical controls, and energy recovery devices), and indirect cost. Indirect cost is calculated from direct capital cost and total capital cost factor, which accounts for equipment installation, building and storage, design and engineering, and miscellaneous cost.

The actual Li adsorption capacity (LAC, mg/g LFP) of the electrode is calculated based on real experimental data using the following equation:

$$LAC = \frac{{◻C}_{in , expr} {V}_{expr}}{\text{?}} \qquad ( 7 )$$

$$\text{?} \text{indicates text missing or illegible when filed}$$

where C_{in,expr} is the concentration of the solution before and after the lithiation; α is the extraction efficiency; Vₑₓₚᵣ is the volume of the circulated solution.

The mass-normalized average Li adsorption rate, ALARₘ [mg/g h], is calculated using equation (8) from LAC, and the duration of a charge-discharge cycle (τ, h):

$${ALAR}_{m} = \frac{LAC}{τ} \qquad ( 8 )$$

The productivity of the plant, Prod, the mass of Li⁺ extracted by the plant per day may be calculated by equation (9):

$$Prod = \frac{\text{?}}{\text{?}} \qquad ( 9 )$$

$$\text{?} \text{indicates text missing or illegible when filed}$$

where cᵢₙ is the Li concentration in the inlet of DLE; Qₒᵤₜ [m³/d] is the influent brine flow rate; Rw is brine recovery, defined as the percentage of brine volume recovered after DLE; and η_{LF} is plant load factor, which is the ratio of average brine flow rate to an installed capacity of brine flow rate. The load factor accounts for the capacity utilization rate and downtime in the DLE plant.

The mass of electrodes (M_{elec}, kg) required for initial capital investment is calculated by:

$${M}_{elec} = \frac{P}{24 ( {ALAR}_{m} )} \qquad ( 10 )$$

Based on the estimated total electrode mass, the electrode area was determined in each module, which was then used to estimate the cost of IEMs and auxiliary module components.

Operating costs (Opex) include electricity, module replacement, maintenance, labor, and chemical costs. Electricity consumption includes electricity for charging the electrodes and pumping brine.

The energy consumed during extraction contains the energy used by cells and pumps:

$${E}_{extr} = {E}_{pump} + {E}_{cell} \qquad ( 11 )$$

The pumping energy consumption is calculated based on the water pumped during the process Qᵢₙ and specific pumping energy, SPE [kWh/m³]:

$${E}_{pump} = SPE ▯ {Q}_{in} \qquad ( 12 )$$

The energy supplied to the DLE cells is calculated by the productivity Prod and the specific energy consumption (SEC), [kWh/kg Li⁺]:

$${E}_{cell} = Prod ▯ SEC \qquad ( 13 )$$

The SEC is obtained using numerical integration of real-experimental energy consumed during lithiation and delithiation half-cycles.

$$SEC = \frac{\text{?}}{\text{?}} \qquad ( 14 )$$

$$\text{?} \text{indicates text missing or illegible when filed}$$

where to is the beginning of lithiation; td is the beginning of delithiation; te is the end of the cycle; v(t) is the voltage profile during the cycle; I is the current [mA]. During delithiation, the current is reversed. and some supplied energy during the lithium capture stage can be recovered in the delithiation stage.

TABLE 4
DLE Technology Parameters

| | Variable | Value | Unit |
|---|---|---|---|
| Financial Parameter | | | |
| Total capital cost | F_{TCC} | 2.0 | (Total capital |
| factor | | | cost/equipment cost) |
| Plant service life | Lₚₗ | 20 | Year |
| Plant Load Factor | η_{LF} | 90 | % |
| Maintenance & labor | F_{ML} | 2 | % of initial total |
| factor | | | capital cost/year |
| Chemical factor | F_{C} | 1 | % of initial total |
| | | | capital cost/year |
| Activated carbon | C_{car} | 10 | $/kg |
| LFP | C_LFP | 20 | $/kg |
| IEM cost | C_{IEM} | 60 | $/m² |
| Electricity cost | VC_electri | 0.07 | $/kWh |
| Discount rate | i | 7 | % |
| Case specifications | | | |
| Brine Li concentration | cᵢₙ | 232 | mg/L |
| Brine flow rate | Qₒᵤₜ | 37.85 | m³/day |
| System parameters | | | |
| Extraction rate | α | 0.18 | |
| Mass of active | M_(LFP,expr) | 65.6 | mg |
| material | | | |
| Cycle length | τ | 16 | h |
| Electrode density | ρ | 0.75 | g/cm³ |
| Operating current | I | 0.892 | mA |
| Specific energy | SEC | 4 | kWh/kg Li+ |
| consumption | | | |
| Specific pumping | SPE | 0.1 | kWh/m³ water pumped |
| energy | | | |
| Brine recovery ratio | Rw | 80 | % |
| IEM lifespan | L_{IEM} | 8 | years |
| Electrode lifespan | L_{elec} | 0.5 | years |
| The number of | n_train | 1 | |
| treatment trains | | | |

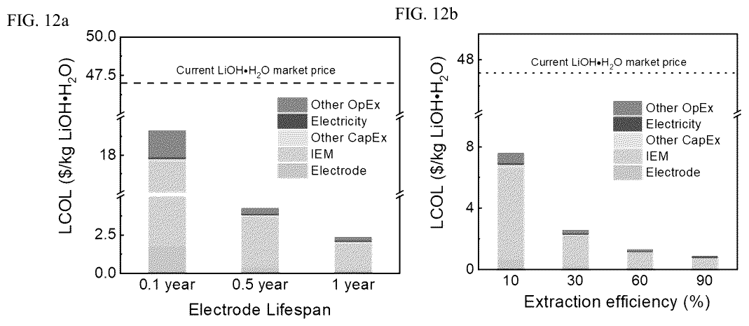

Based on this analysis (Table 4), the unit cost for extracting Li (see FIGS. 12a and 12b) was estimated. This analysis only considers the intercalation unit for lithium extraction and release. The LCOL, with a unit of $/kg LiOH·H₂O, strongly depends on the electrode lifespan and weakly depends on the Li extraction efficiency (because the cost is normalized to the mass of Li extracted). With the system baseline parameters used in our analysis (electrode lifespan 0.5 years (see Table 4), the LCOL is 4.1 $/kg LiOH·H₂O, approximately 10 times lower than the current market price for LiOH·H₂O.

Electricity-driven lithium extraction follows the trends of industrial electrification. The direct lithium extraction system and processes described herein demonstrate a different concept from conventional chemical mining methods. A three-electrode flow system was designed coupled with lithium intercalation materials to achieve high lithium selectivity over all other cations under well-controlled potential. Three-electrode configuration has previously been demonstrated in static beaker system. In flow cell ion separation works, two-electrode configuration is widely applied in capacitive deionization and intercalation deionization. However, both Li⁺ and Na⁺ are able to intercalate into FePO₄ interstitial sites but at different plateau voltage⁷, working electrode potential is difficult to control when counter electrode as the reference captures anions. Accordingly, the hybrid intercalation deionization with a reference electrode to accurately control the potential for lithium intercalation was first demonstrated.

Compared with other direct lithium extraction methods, intercalation deionization extraction as described herein shows outstanding lithium selectivity and minimizes the mining environmental impacts. Lithium adsorbents and some organic solvents have a high affinity for Li⁺ but acid and organic reagents are needed during the process. Additional studies on lithium separation by membrane-based technologies including pressure driven and electric field driven membrane process have been described. Most prior work demonstrates lithium selectivity over multivalent cations but rarely discuss lithium selectivity over monovalent cations like sodium and potassium. Moreover, chemical consumption is still needed to refine the lithium from monovalent cations to obtain high purity lithium product. See Table 5.

TABLE 5

| Ions | Influent ratio (molar) | Selectivity P | Process |
|---|---|---|---|
| Li⁺/Na⁺ | 1:77 | 2.05 × 10³ | Present Invention |
| | ~1:709 | 44 | Adsorption |
| | 1:0.8 | 9.76 | Adsorption |
| | 1:1 | 18.22 | Adsorption |
| | 1:1 | 1.5 | Membrane |
| | 1:1 | ~2.3 | Membrane |
| | 1:1 | ~5.28 | Solvent |
| Li⁺/K⁺ | 1:14.3 | 4.41 × 10³ | Present Invention |
| | 1:1 | 1.85 | Membrane |
| | ~1:24 | 780 | Adsorption |
| | 1:1 | 30.57 | Adsorption |
| | 1:1 | ~12.3 | Solvent |
| Li⁺/Ca²⁺ | 1:23 | 1.48 × 10⁴ | Present Invention |
| | ~1:1.9 | 20 | Adsorption |
| | 1:1 | 0.94 | Membrane |
| Li⁺/Mg²⁺ | 1:0.05 | Undetected | This work |
| | 1:1 | 57.7 | Adsorption |
| | 1:1 | 15.14 | Adsorption |
| | ~1:72.6 | 40 | Adsorption |
| | 1:1 | 0.58 | Membrane |
| | 1:1 | ~10 | Membrane |
| | ~1:11.9 | ~257 | Precipitation |

### EXPERIMENTAL

### Preparation of Electrodes

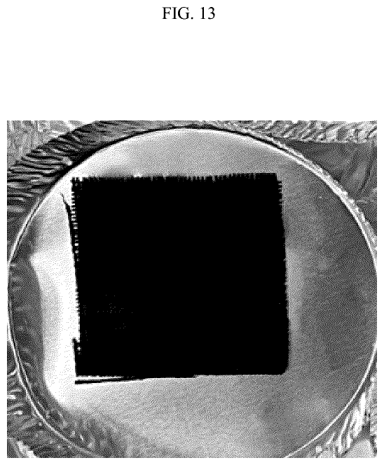

All FePO₄ electrodes were prepared by casting a slurry of LifePO₄, Super P carbon black (MTI Corporation; Item Number: Lib-SP; average particle size ˜40 nm; purity ≥99.5%), and polyvinylidene fluoride (Fisher) with a mass ratio of 80:10:10 in N-methyl-2-pyrrolidone. The electrode slurry was drop-casted on a 3×3 cm² geometrical surface of a porous carbon cloth (ELAT-H, FuelCellEtc, 406 μm in thickness, 80% porosity) and dried in an oven at 80° C. overnight (see FIG. 13). The active material mass loadings ranged between 50±5 mg/cm².

### Brine Preparation

The recipe-salts (Table 2) were completely dissolved with stirring, after sparging nano-pure (>18.2 MΩ·cm) water with nitrogen for 30 minutes. The brine pH was then adjusted to ˜5.5with sodium hydroxide and hydrochloric acid solutions (as required).

### Electrochemical Methods

All electrochemical operations were performed on a Bio-Logic VSP potentiostat at room temperature (20˜25° C.).

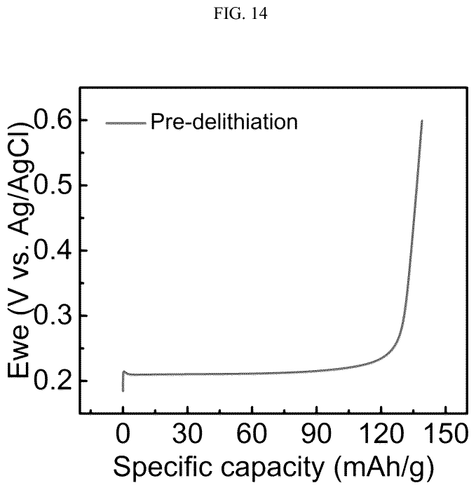

During pre-delithiation process, LiFePO₄ (LFP) working electrodes were paired with Pt counter electrodes and Ag/AgCl reference electrode for galvanostatic Li-ion deintercalation in 100 mL 1 M LiCl with 0.1 C rate (1 C is equivalent to 147 mA/g specific current) (see FIG. 14). After pre-delithiation, electrodes were rinsed with DI water to remove adsorbed Li⁺ and ready for the intercalation process.

Intercalation deionization is one of the configurations of generalized capacitive deionization (CDI), an electric field-driven process to separate ions from water based on the principle of ion storage in the porous carbon electrodes or intercalation electrodes. During the charging step, a potential bias is applied across the two electrodes, and ions migrate to and are stored capacitively in the electrical double layers within the porous carbonaceous electrodes or inserted into the intercalation electrodes. During the discharging step, the potential bias is released, and ions are released back to the bulk solution.

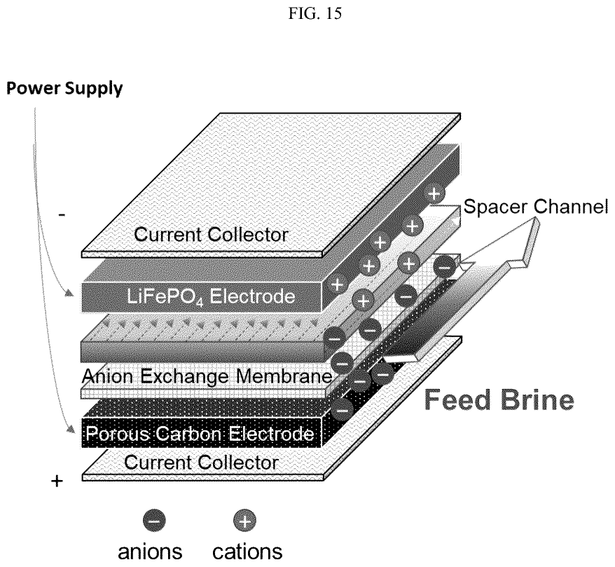

The IDI cell consists of rectangular acrylic plates (McMaster), rubber gaskets, a plastic mesh spacer, a pair of graphite current collectors, a piece of LFP electrode and a piece of carbon electrode. Schematic and assembling details of an exemplary cell are shown in FIG. 15. The sizes of the electrodes were 3×3 cm. An AEM was placed between the positive electrode and the mesh separator.

All IDI experiments were performed in the flow-by (i.e., solution flows in parallel to the electrode pairs) mode with single-pass operation (i.e., effluent does not recirculate back to the feed). Prior to experiments, the carbon electrodes were infiltrated with the working solution in vacuum for 30 min. The assembled IDI cell was then equilibrated with the working solution for overnight. During lithium extraction, solutions were continuously flowed through the IDI cell at a flow rate of 0.5 mL/min with 0.1 C rate. During lithium release, 5 mM LiCl solution was continuously flowed through the IDI cell at a flow rate of 0.05 mL/min with 0.1 C rate. DI water was flashed into the cell for washing between lithium extraction and release process.

Bipolar membrane electrodialysis (BMED) is one of the configurations of electrodialysis (ED), a continuous electric field-driven process to separate opposite charged ions. Bipolar membranes could generate H⁺ and OH⁻ on each side surface of the membrane under electric field. BMED cell (PCCell ED 64004) was assembled with bipolar membranes and cation exchange membranes. 10 mM LiCl and DI water was fed in as dilute-in and concentrate-out streams at 5 mL/min. 2.0V was applied as constant voltage for 2 hours. N₂ (purity >99.998%) was continuously bubbled into the solution to avoid CO₂ dissolution.

### Materials Crystallization

LiOH powder was collected under reduced pressure using a BUCHI rotavapor R-300. The solution was heated to 80° C. and placed under 0 mbar pressure to remove water. The damp solid was lyophilized for 48 hours using as a labconco FreeZone benchtop freeze dryer system. The remaining LiOH solid was ground into a fine powder for imaging.

### Materials Characterization

Surface morphology was characterized by a field-emission scanning electron microscope (FE-SEM, FEI Teneo LV) at an acceleration voltage of 2 kV. Scanning transmission electron microscope (STEM) images were acquired using JEOL ARM 200F equipped with a coldfield emission source operated at 200 kV. STEM-EDS mapping was acquired using an Oxford X-Max 100TLE windowless SDD detector equipped with JEOL ARM 200F. EELS spectra were acquired using a Gatan GIF Continuum ER with a dwell time of 0.03 s per pixel.

All patents and other references cited herein are incorporated by reference.

1. A process for extracting lithium from brine, the process comprising
(i) removing silica from the brine;
(ii) intercalating lithium ions onto a cathode;
(iii) storing chloride ions on an anode;
(iv) adding water;
(v) releasing the lithium ions from the cathode and the chloride ions from the anode to form lithium chloride; and
(vi) converting the lithium chloride to lithium hydroxide.

2. A process for preparing lithium hydroxide from brine comprising
(i) removing silica from the brine;
(ii) intercalating lithium ions onto a cathode;
(iii) storing chloride ions on an anode;
(iv) adding water;
(v) releasing the lithium ions from the cathode and the chloride ions from the anode to form lithium chloride; and
(vi) converting the lithium chloride to lithium hydroxide.

3. The process of claim 1, wherein step (i) comprises aerating the brine to convert Fe²⁺ to Fe³⁺.

4. The process of claim 1, wherein step (i) comprises precipitating the silica from the brine as iron (III) silicate.

5. The process of claim 1, wherein step (i) further comprises electro-coagulation with an iron or aluminum electrode.

6. The process of claim 1, wherein the cathode comprises an intercalation material selective to lithium ions (Li⁺).

7. The process of claim 1, wherein the cathode comprises lithium iron phosphate (LiFePO₄), lithium manganese oxide (LiMn₂O₄), lithium cobalt oxide (LiCoO₂), lithium titanium oxide (Li₂TiO₃), or any combination thereof.

8. The process of claim 1, wherein the anode comprises a carbonaceous material.

9. The process of claim 1, wherein steps (ii) and (iii) are conducted at a voltage of between about 0.6 and about −0.2 V vs Ag/AgCl.

10. The process of claim 1, wherein step (iv) removes desorbed lithium and/or chloride ions.

11. The process of claim 1, wherein step (v) comprises reversing the voltage.

12. The process of claim 1, wherein step (vi) comprises bipolar membrane electrodialysis (BMED).

13. The process of claim 1, wherein the purity of the lithium hydroxide is greater than about 90%.

14. The process of claim 1, wherein the lithium hydroxide is lithium hydroxide monohydrate.

15. The process of claim 1, wherein greater than about 90% of the lithium in the brine is selectively extracted.

16. The process of claim 2, wherein step (i) comprises aerating the brine to convert Fe²⁺ to Fe³⁺.

17. The process of claim 2, wherein step (i) further comprises electro-coagulation with an iron or aluminum electrode.

18. The process of claim 2, wherein the cathode comprises an intercalation material selective to lithium ions (Li⁺).

19. The process of claim 2, wherein the anode comprises a carbonaceous material.

20. The process of claim 2, wherein the purity of the lithium hydroxide is greater than about 90%.
